(19) United States
(12) Patent Application Publication
(10) Pub. No.: US 2021/0374200 A1
(43) Pub. Date: Dec. 2, 2021

(54) CLOUD CONNECTED TRAVEL SYSTEM WITH CARRYING CASE

(71) Applicant: TRAVEL LIGHT LTD, Tel Aviv (IL)

(72) Inventors: Netta Shalgi, Tel Aviv (IL); Charles H. Cella, Pembroke, MA (US)

(21) Appl. No.: 15/733,043

(22) PCT Filed: Sep. 29, 2018
(86) PCT No.: PCT/IB2018/057592

§ 371 Date: Apr. 28, 2020

Related U.S. Application Data
(60) Provisional application No. 62/565,735, filed on Sep. 29, 2017.

(51) Int. Cl. G06F 16/9535; G06F 16/9536; G06F 1/16; A45C 15/00

(52) U.S. Cl. CPC G06F 16/9535; G06F 16/9536; G06Q 50/14; A45C 15/00; G06F 1/1628

(57) ABSTRACT

The present teachings include a carrying case that offers connectivity and versatility to a user including a housing of the carrying case having a main compartment and at least one technology compartment. The housing is configured to have a closed position and an open position that provides access to the main compartment for placement and removal of items in the carrying case. A mobile computing device is contained in the at least one technology compartment. The mobile computing device is configured to store at least one identifier for the user of the carrying case. A travel information module is associated with the mobile computing device to receive travel information of the user based on the at least one identifier of the user. The travel information includes at least one itinerary data item of the user.

### CROSS-REFERENCE TO RELATED APPLICATIONS

This application claims priority of U.S. Application Ser. No. 62/565,735, filed on Sep. 29, 2017. The entire disclosure of the above application is incorporated herein by reference.

### FIELD

The present invention relates to a connected travel system with a carrying case having information technology components and features that connect with travel services, mobile devices and applications of the user.

### BACKGROUND

Travel, whether for work or personal reasons, can entail numerous problems and challenges, including challenges in trying to anticipate in advance the needs that may arise during a trip, challenges in dealing with transportation, challenges navigating airports and other terminals, challenges in packing and re-packing, and others. Most travelers travel with one or more carrying cases, such as luggage, backpacks, briefcases, and various specialized case and carriers for specific items, such as pets, musical instruments, cameras, tools, equipment, and the like, most of which have handles, straps or the like and some of which are outfitted with wheels to facilitate rolling. Some of these carrying cases are equipped with features like USB chargers or Bluetooth locks that employ some basic information technology features; however, current carrying cases are typically passive components of the user's travel experience. A need and opportunity exists for carrying cases to provide a much higher level of intelligence, actively addressing a variety of the challenges that face travelers.

### SUMMARY

Provided herein are methods and systems for enabling a highly intelligent carrying case that includes and connects to a wide range of information technology components and features, including components and features enabled in the cloud and components and features enabled on a user's mobile device, such as in embodied in one or more mobile applications, such that the needs of a traveler are anticipated and met by the coordinated action of the various components and features. In embodiments, the carrying case is a wheeled carrying case, such as a wheeled luggage case. While many of the embodiments below are described in connection with a wheeled luggage case, it should be understood that the various methods, systems, components, features and the like described in connection with such embodiments may be applied to any of a wide variety of carrying cases, including luggage, backpacks, duffel bags, briefcases, purses, pet carriers, camera cases, tool boxes, and other boxes, cases, and the like for carrying tools, specialized equipment, and other items, all of which are collectively intended to be encompassed by references to a “carrying case,” a “case,” “luggage,” or the like, except where context indicates otherwise. Also, while many embodiments are described in connection with the use of wheels, it should be understood that elements of such embodiments are provided for illustration and are intended to encompass use of the same in connection with cases that do not have wheels, except where context indicates otherwise.

In embodiments, the carrying case may include a number of features that enable intelligence, including an on-board information technology infrastructure that may include a processor, memory, an operating system, communications facilities (including cellular, Internet, Bluetooth, WiFi, and/or other long-range or location communications capabilities), and one or more applications and programs (which may include programs that support user interface features on the carrying case, programs that manage power for the information technology infrastructure, and programs that operate on inputs from a user, from one or more sensors, and/or from one or more external sources of information to address one or more needs of a user). Programs may use intelligence, including machine learning, to adapt to the needs of a user, such as based on a profile of the user (which may be determined based on input of the user, analysis of one or more characteristics of the user (including based on similarity to other users), and/or tracking of actions of the user over time). The communications capabilities may allow the carrying case to connect to the cloud and/or to one or more other devices, which may include the user's mobile phone or other electronic device and may include other external systems, such as information technology infrastructure of a user's home, information technology infrastructure of a travel environment (such as in an airport terminal or other terminal), and the like. In embodiments, components and features to enable the carrying case may be located in the cloud or other remote environment, such as using one or more servers, databases, and the like, such as embodied in various applications, services, programs and the like and deployed on one or more web services platforms, infrastructure-as-a-service platforms, platform-as-a-service platforms, or other private or public cloud infrastructure. These may include one or more software development kits that allow one or more developers to develop services, applications, and the like that can be used to enable new features for the carrying case or enable users to take advantage of the features of the carrying case. In embodiments, the cloud may include one or more modules for collecting data about the user (including data relating to use of various other services and components on the carrying case, in the cloud and in any related application, such as a mobile application, as well as data about other items, such as anticipated travel for the user, weather data, data about travel infrastructure, data about warnings and alerts, data about traffic and delays, and many other items of data relevant to a trip), modules for profiling users, modules for analyzing user profiles to determine similarity of users (such as for collaborative filtering and the like), modules for predicting and anticipating states of the user (such as based on other collected data and optionally including use of machine learning), modules for managing interactions with users (including handling user interfaces and managing work flows based on user input and other data), modules for managing inputs from external data sources (such as from databases, servers, sensor networks, and others), modules for managing interactions with external systems (such as involving data transformations necessary to extract, transform and load data to and from external systems), modules for routing and navigation (such as to guide a user to a next point in an itinerary, or to guide a user to a spot to meet a particular need), and others. In embodiments, one or more mobile applications may operate on the device of the user to facilitate use of the intelligent features of the carrying case, such as to provide the user with input from the carrying case, to instruct the user in use of the carrying case, to guide the user through preparation for travel (including packing), to allow the user to plan a trip, to allow the user to select and/or modify options available through the carrying case, and many others. Collectively, the carrying case, the cloud-deployed components and features, and the components and features of the one or more mobile applications can enable a vastly improved travel experience for the user.

In embodiments, the carrying case and other elements described herein that coordinate with the carrying case may extract, collect, monitor, operate on, use, transform, load, modify, and/or output a wide range of travel information, including through a wide range of data handling facilities, such as user interfaces, application programming interfaces, sensor interfaces, databases and other data storage facilities, metadata facilities, data transformation facilities (such as for extraction, transformation and loading data between systems that use different formats), connectors, bridges, message brokers, and the like. References throughout this disclosure to use of travel information by various information technology components should be understood to encompass any of these kinds of uses of any of these kinds of elements, except where context indicates otherwise.

Travel information handled by the methods and systems disclosed herein may include a wide range of information relevant to planning, scheduling, preparing for, packing for, engaging in and unpacking from a trip, such as itinerary information (including point of origin, destination and intermediate stops), route information, point of interest information, information about user needs, ticketing information, loyalty program and rewards information (such as miles), accommodations information, transfer/connection information, infrastructure information (such as relating to terminals, ports and the like), travel vehicle information (such as about aircraft, buses, trains, ships, and other vehicles), information about travel alerts and warnings, information about delays, information about alternative methods of travel, information about costs and pricing, information about upgrades, information about seating, information about food and beverage options, information about entertainment options, information about climate and/or weather, information about clothing, information about facilities (such as location, type, hours of operation, and the like), information about the purpose of a trip, information about the purpose of a meeting, information about local customs, information about dress codes, information about travel accessories, information about levels of supply, information about missing items, packing checklist information, information about rules and regulations, information about allowed items for transport, information about priority, information about pre-clearances, information about companion travelers, information about travel preferences, demographic information (including age, income, and local), and a wide range of other information and use of the term “travel information” should be understood to encompass any of these types of information and other information relevant to a travel experience of a user, unless context indicates otherwise.

### BRIEF DESCRIPTION OF THE DRAWINGS

The many aspects of the present teachings and how they may be implemented in practice are described below by way of non-limiting examples and with reference to the accompanying drawings.

FIG. 1 is a diagram of a portable carrying case that contains a travel information module that connects through the cloud to various travel services and infrastructures and the mobile devices of the user in accordance with the present teachings.

FIG. 1 is a general view of an axle-free wheel case in accordance with the present teachings.

FIG. 2 is an isometric exploded view of an axle-free wheel in accordance with the present teachings.

FIG. 3 is a partial cross-sectional view of an axle-free wheel of FIG. 2.

FIGS. 4 and 5 are general and enlarged partial views of an external rim, respectively, of FIG. 2.

FIGS. 6 and 7 are general and enlarged partial views of an internal rim, respectively, of FIG. 2.

FIG. 8 is an isometric view of a roller of FIG. 2.

FIGS. 9 and 10 are general and enlarged partial views of annular members, respectively, of FIG. 2.

FIGS. 11 and 12 are general and enlarged partial views of external plates, respectively of FIG. 2.

FIG. 13 is an isometric exploded view of a side expandable wheeled case of FIG. 1.

FIGS. 14a, 14b, 14c, 14d, 14e, and, 14f present side extendable expandable wheeled cases in unexpanded, semi-expanded and fully expanded position in accordance with further aspects of the present teachings.

FIGS. 15a, 15b, 15c, and 15d are isometric exploded views of axle-free wheel case provided with a receiving plate in accordance with other aspects of the present teachings.

FIGS. 16a, 16b, 16c, and 16d are schematic views of a cord-driven wheeled case in accordance with further aspects of the present teachings.

FIG. 17 is an isometric internal view of a wheeled luggage case provided with an electric generator in accordance with additional aspects of the present teachings.

FIGS. 18 and 19 are general and enlarged partial views of a wheeled luggage case provided with a USB port, respectively, in accordance with yet additional aspects of the present teachings.

Fig. F100 is a flowchart illustrating a method associated with a packing guidance module in accordance with the present teachings.

Fig. G100 is a flowchart illustrating a method associated with an intelligent trip itinerary module in accordance with the present teachings.

Fig. H100 is a flowchart illustrating a method associated with an intelligent trip guidance module in accordance with the present teachings.

FIG. 20 is a bottom view of a wheeled luggage case provided with fixed supporting members in accordance with one aspect of the present teachings.

FIG. 21 is a bottom view of a wheeled luggage case provided with ball bearing members in accordance with another aspect of the present teachings.

FIG. 22 is a side view of the wheeled luggage case of FIG. 1 placed on its side.

FIGS. 23a, 23b, and 23c are isometric views of the luggage case of FIG. 1 in closed, semi-opened and open positions, respectively.

FIGS. 24a and 24b are isometric internal views of a compartmented wheeled luggage case in accordance with yet another aspect of the present teachings.

FIGS. 25a and 25b illustrate an X-ray security procedure in accordance further aspects of the present teachings.

FIGS. 26a, 26b, 26c, and 26d illustrate withdrawing a wheeled luggage case from a car trunk in accordance with further aspects of the present teachings.

FIGS. 27, 28a, and 28b illustrate a wheeled luggage case being towed by a bicycle in accordance with another aspect of the present teachings.

FIGS. 29a and 29b are isometric views of a book-like openable case in closed and open positions, respectively in accordance with further aspects of the present teachings.

FIGS. 30a and 30b are isometric views of a book-like openable case with collapsed and deployed axle-free wheels in accordance with additional aspects of the present teachings.

FIG. 31 is an isometric exploded view of a book-like openable case of FIGS. 30a and 30b.

FIG. 32 is an isometric view of a book-like openable case of FIGS. 30a and 30b illustrating axle-free wheels deploying.

### DETAILED DESCRIPTION

The following description is provided so as to enable any person skilled in the art to make use of the many inventions defined in the claims and set forth in many examples that include various modifications and the best modes contemplated for carrying out these inventions.

The term “labyrinth axle-free wheel” refers hereinafter to a wheel mechanically attachable to a housing plane, whereat a wheel plane is parallel to the plane of attachment.

The term “ground interface” refers hereinafter to a member circumferentially distributed over the external rim of the wheel that is configured to be in contact with the ground.

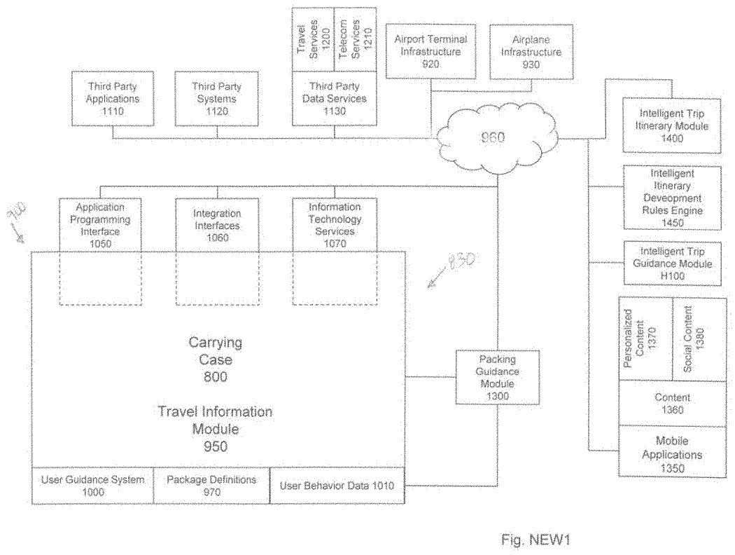

Reference is now made to FIG. 1, presenting a general view of a wheeled case 510 provided with a pair of labyrinth axle-free wheel 100 mounted flush with case wall within a slot 770.

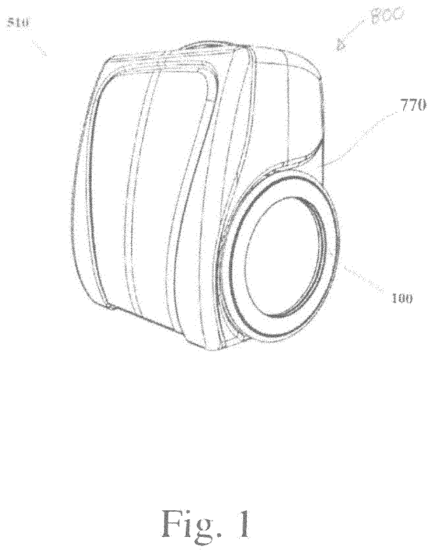

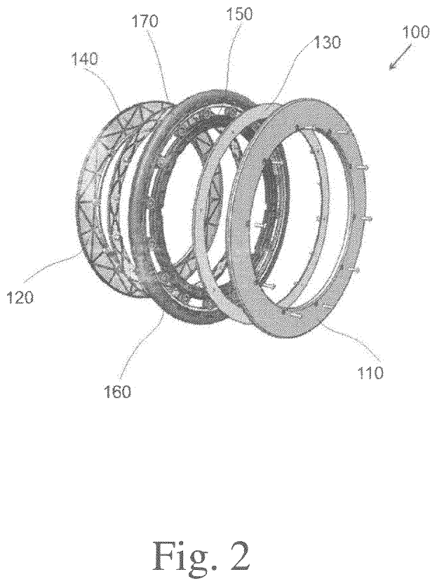

Reference is now made to FIG. 2, presenting an exploded view of a labyrinth axle-free wheel 100 which includes an external rim 160 provided with a ground interface, an internal rim 150, rollers 170 rotatably disposed within a roller spacer consisting of two mechanically tied together annular members 130 and 140. Annular members 110 and 120 cover the wheel on the sides. The wheel articles are mechanically assembled together and attached to portions of a main housing of the wheeled case 510 that define housing planes on each side of the housing. The housing planes can be parallel to the wheel plane.

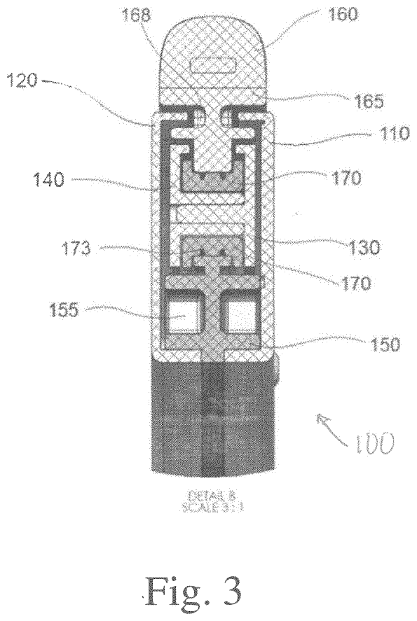

FIG. 3 details an enlarged partial cross-sectional view of the wheel 10 that specifies a labyrinth dust configuration. The labyrinth is defined by annular members 110 and 130 on the right side and 120 and 140 on the left side, the internal rim 150 and the external rim 165. The dust is adhered to internal surfaces of members 110, 120, 130 and 140 which as shown below are provided with special dust chambers. Additionally, the external rim 165 is provided with a dust chamber 168 and the internal rim 150 with a dust chamber 155. Optionally, the rollers 170 can be provided with at least one circumferential groove 173.

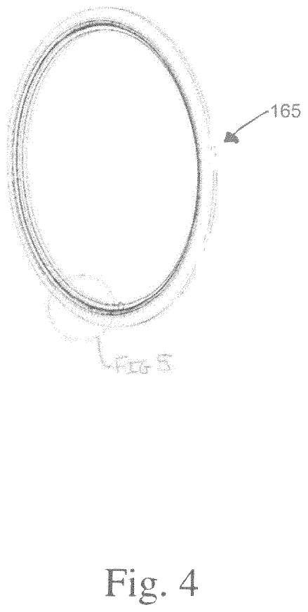

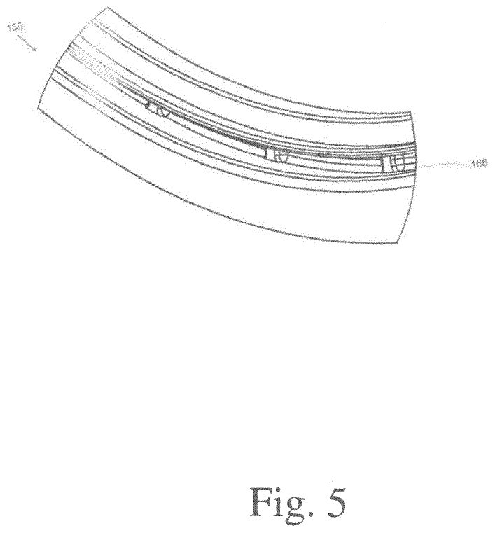

Reference is now made to FIGS. 4 and 5 presenting general and enlarged views of the external rim 165. The enlarged view specifies geometric configuration of dust chambers 168 circumferentially distributed over the rim 165.

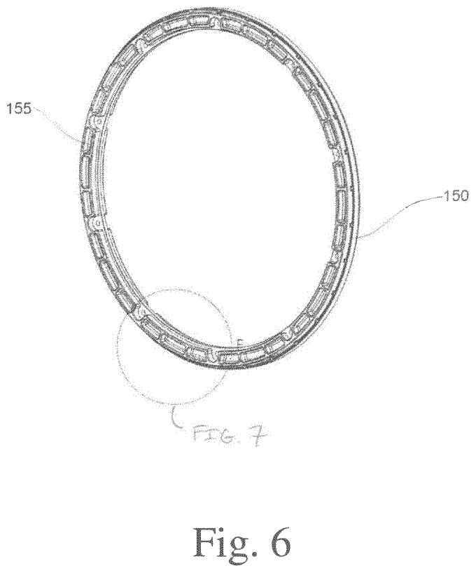

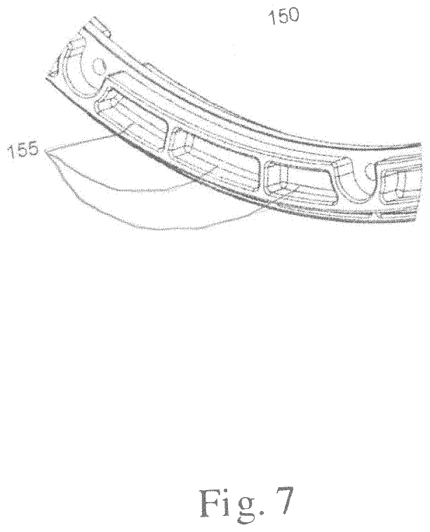

Reference is now made to FIGS. 6 and 7 presenting general and enlarged views of the internal rim 150. The enlarged view specifies geometric configuration of dust chambers 155 circumferentially distributed over the rim 150.

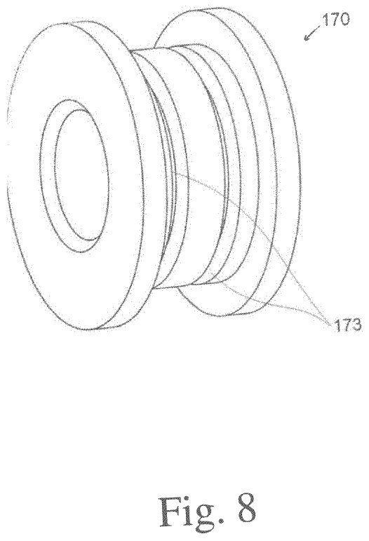

Reference is now made to FIG. 8 presenting a general view of the roller 170 which, according to one embodiment of the present invention is provided with at least one groove 173 which serves for dust gathering in proximity of the roller 170 preventing the roller 170 from jamming due to dust obstruction.

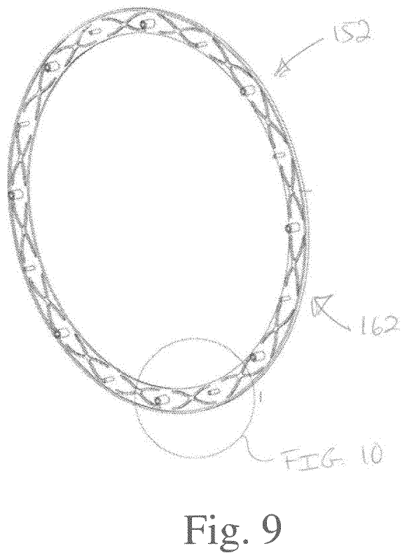

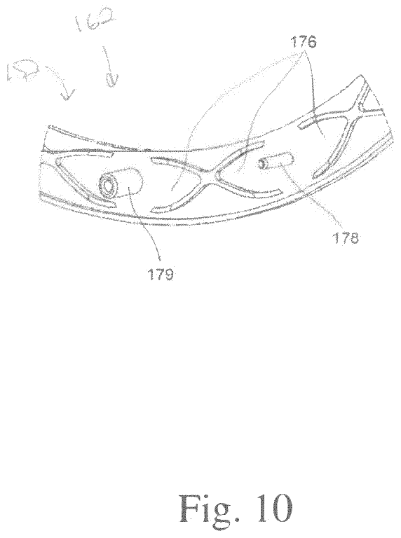

Reference is now made to FIGS. 9 and 10, presenting general and enlarged views of the separator annular member 150, 160. The enlarged view specifies geometric configuration of dust chambers 176 circumferentially distributed over the separator annular member 150, 160. When assembled, the member 150 is angularly displaced relative to the member 160 such that an entire pintle 178 is inserted into a slot pintle 179.

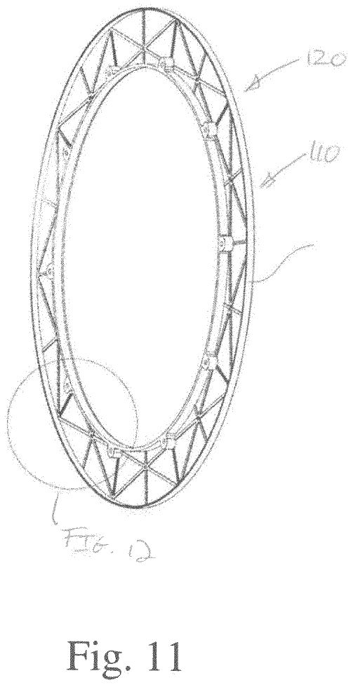

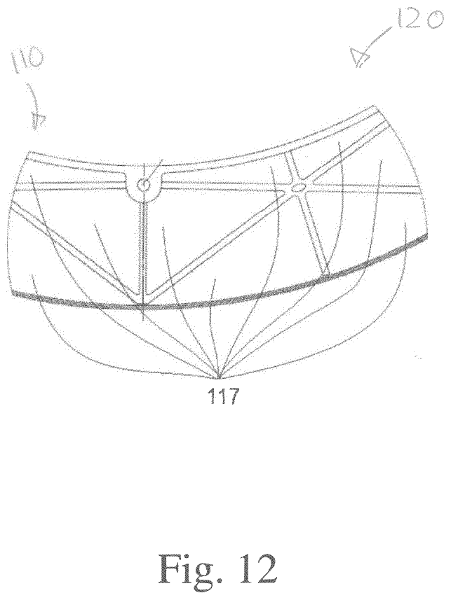

Reference is now made to FIGS. 11 and 12, presenting general and enlarged views of the external cover annular member 110, 120. The enlarged view specifies geometric configuration of dust chambers 117 circumferentially distributed over the external annular member 110, 120.

Reference is now made to FIGS. 13a and 13b presenting views of a side expandable wheeled luggage case. In accordance with one embodiment of the present invention, the luggage case comprises a telescopically expandable frame 330 coated with a cover material, side walls 320 with a mounting face 310 configured for mounting the wheel 100. Numeral 335 refers to a telescopic mechanism in an expanded position. The side walls 320 are provided with members 350 supporting the case in a horizontal position (for example, when the case is opened). According to one embodiment of the present invention, the members 350 can be replaced with ball bearing members (not shown) enabling case towing in the horizontal position. The luggage case is moved by a telescopically configured extension handle mechanism 340.

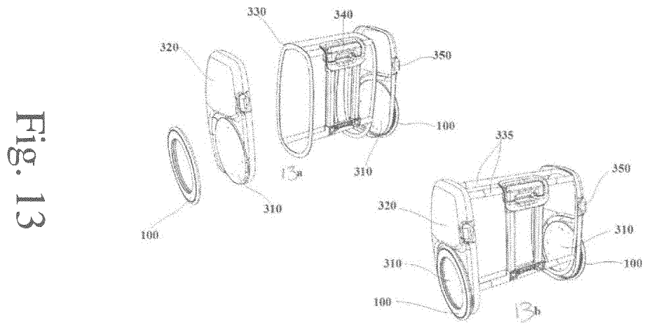

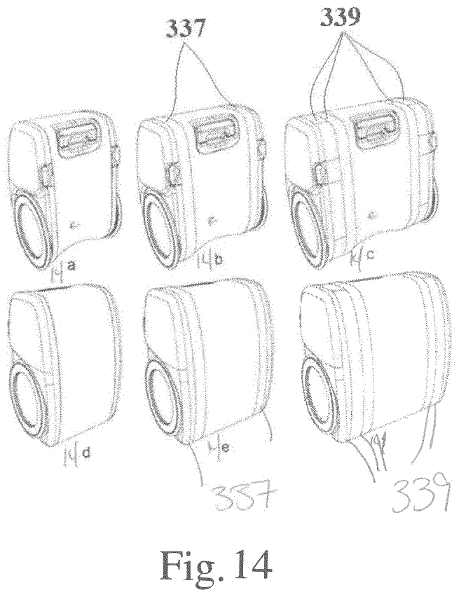

Reference is now made to FIGS. 14a-14f, presenting differently expanded luggage cases. Specifically, in an exemplar manner, areas 337 or 339 can be expanded by unzipping the aforesaid areas and an expansion mechanism can widen the luggage case. The expansion mechanism can include telescopic members embedded into said frame, spring-loaded members, and the like.

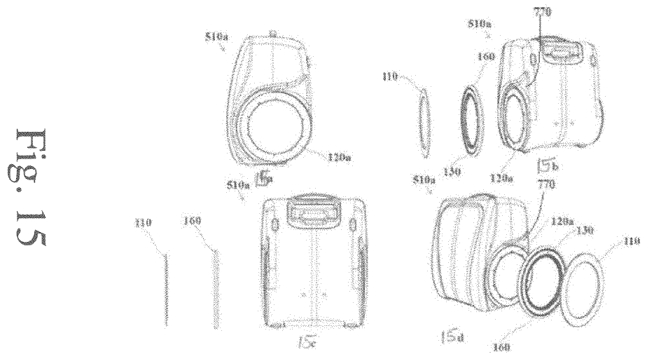

Reference is now made to FIGS. 15a-15d, showing a specific embodiment of the present invention provided with an external cover member 120a built into a slot 770 which is a part of the case wall.

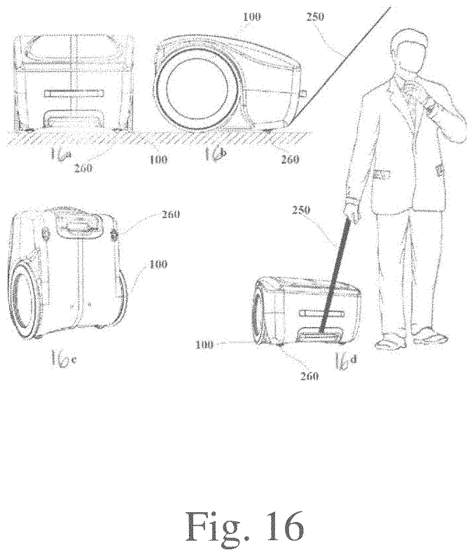

Reference is now made to FIGS. 16a-16d, showing a further embodiment of the present invention towable in a horizontal position by a cord system 250. The luggage case is moved on wheels 100 and ball bearing rotatable supporting members 260.

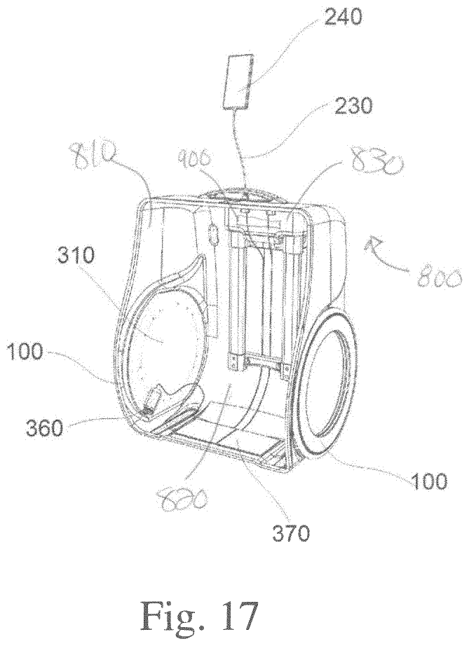

Reference is now made to FIG. 17, presenting a schematic internal view of the luggage case. An electric generator 360 is in a rotational connection with the wheel 100, such that when a user moves the luggage case, the generator 360 charges a battery 370 which can be used for further charging user's mobile devices 240 via USB-connector.

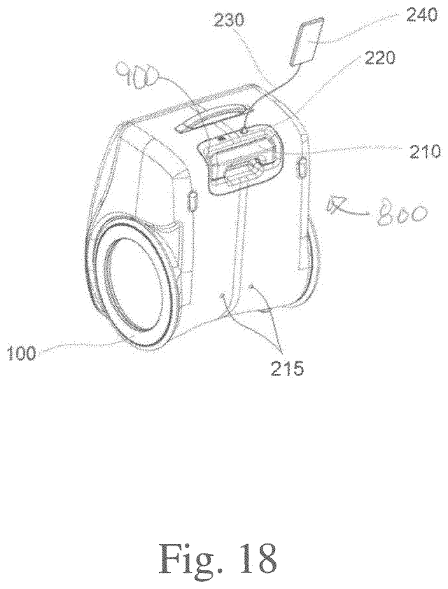

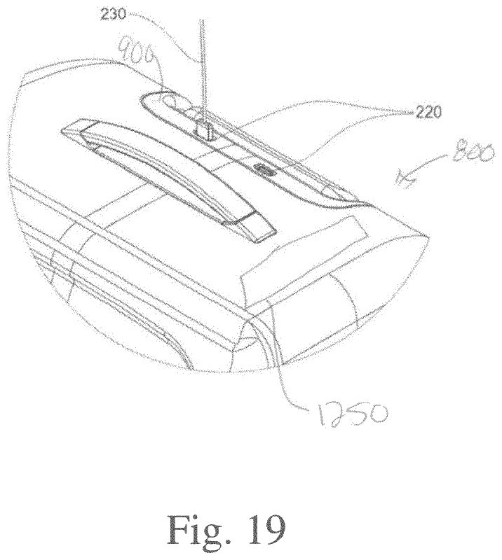

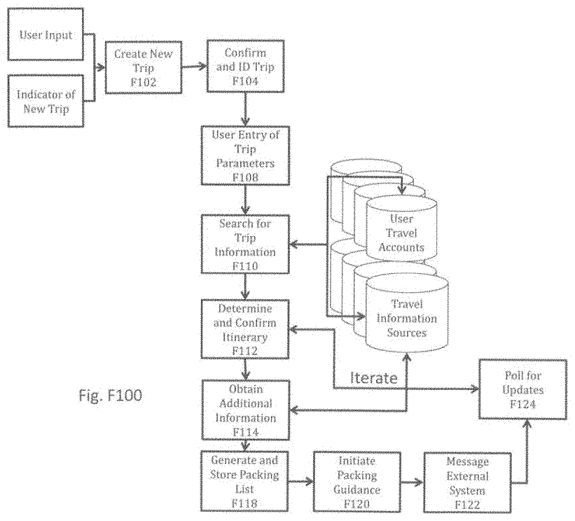

Reference is now made to FIGS. 18 and 19, presenting a wheeled luggage case with axle-free wheels 100. The luggage case is provided with a waterproof USB-connector 220 for charging a mobile device 240. The aforesaid device 240 is connected to the USB-connector 220 with a cable 230. Numeral 215 refers to external lights configured for illuminating a user's path and enhancing convenience and safety of case use.

Reference is now made to FIGS. 1, 17, 18, and 19, presenting additional topologies and arrangements for electronic and information technology components that can be provided in a carrying case 800 in accordance with the many aspects of the present teachings. The carrying case 800 can optionally include the labyrinth axle-free wheels 100 on both sides of the carrying case 800, but the electrical and information technology components can also be housed in other forms, with or without wheels.

In embodiments, a housing 810 of the carrying case 800 can define a main compartment 820 (such as for belongings in the case of luggage, or other cargo in the case of other types of carrying case) and a technology compartment 830, which in embodiments may both be accessible when the housing is moved into an open position 840 and one or more of which may not be accessible when in the closed position 50. The technology topologies and arrangements in the technology compartment can include wired and wireless connections that can deliver and receive electrical power and can provide data connections 860 to one or more mobile devices 240 of the user of the carrying case 800 and/or to the cloud. By way of the above example, the mobile device 240 can connect to a mobile computing device 900 in the technology compartment 830 and can interact and exchange information with many wired and wireless interfaces, such as cellular communications, Internet communications, Ethernet, WiFi. BlueTooth™, NFC, Zigbee™, fiber optic communications, cable communications, and others. Interfaces may include ones enabled by software, middleware, and firmware, including suitable user interfaces (which may include graphical user interfaces, touch screens, buttons, sliders, toggles, icons and the like) and optionally including one or more application programming interfaces (APIs) that enable interaction with one or more programs, applications, modules, services, or the like that are deployed on the information technology infrastructure of the carrying case, in the cloud, or on one or more other systems, such as a mobile device. By way of example, connections can occur between the carrying case 800 and a mobile device 240 of a user, such as using a USB device 220, a Bluetooth™ connection, or the like. The carrying case 800 can include other wired and wireless ports to exchange information between the carrying case 800 and another system, such as a cloud-based system, the mobile device 240, or other external system, such as the infrastructure of an airport terminal 920 or other terminal, the infrastructure of an airplane 930, or the like.

In the various aspects of the present teachings, the carrying case 800 in the open positon 840 can provide access to the user to the main compartment 820 and the technology compartment 830 defined in the housing 810. The mobile computing device 900, which may be an integrated device or a set of separate components operating together under common control and may include the various elements described throughout this disclosure, such as processor(s), memory elements, programs, modules, applications, services, and the like, can be contained in the technology compartment 830 and can include, for example, a travel information module 950 that is configured to connect to a cloud network facility 960, to a mobile device 240 of the user and/or to another external system (such as a kiosk in an airport terminal) to exchange travel information or portions thereof such as a travel itinerary or individual portions of the travel itinerary such as one or more itinerary data items. The travel information module 950 can include a packing information and definitions 970 and can further include—or gather through the cloud network facility 960—any of the various other types of travel information described throughout this disclosure.

In accordance with additional aspects of the present teachings, the travel information module 950 of the mobile computing device 900 can a technology stack that offers layers of functionality for the mobile computing device 900. The layers of functionality can be resident and part of the travel information module 950 in the mobile computing device 900 or in other instances the layers of functionality can be accessed through the cloud network facility 960, through a user's mobile phone or other device, through another external system, or through a combination of these. The travel information module 950 in the mobile computing device can include, for example, a user guidance system 100 and the packing definitions system 970. The travel information module 950 can also access information about the user, such as the user's profile, such as based on user input, behavioral data (including based on tracking of the use of the carrying case), comparison to other users, and the like that can be collectively user behavior data 1010. In further aspects, the travel information module 950 can also include data connectivity functionality that can be provided through application programming interfaces 1050, integration interfaces 1060 and information technology services 1070 than include or share functionality with resident systems, through connectivity with the cloud network facility 960, through the mobile devices 240 of the user, and combinations thereof.

It will be appreciated in light of the disclosure that mobile devices or mobile computing devices of the user can include smart phones, tablets, phablet, laptops, desktops, car-based mobile devices, wrist-based wearables, eyeglass-based wearables, household computing devices, public kiosks, desktop computers, hosted-computing sessions on terminals, home automation systems, home security systems, and the like.

The various modules of the travel information module 950 including the application programming interfaces 1050, integration interfaces 1060, and information technology services 1070 can reside on or be local to the mobile computing device 900 in the technology compartment 830 of the luggage case 800, or can be external and accessed through connectivity through the cloud networking facility 960 or through other communications capabilities noted above (such as Bluetooth™ connection to a user's mobile phone or other device). The application programming interfaces 1050 can be used to connect to or be embedded in third party applications 1100 and can provide travel information or portions thereof to the user, such as information relevant to a given travel itinerary, information about what is packed in the main compartment, or the like. Examples of third party applications can include Yelp™ search tools, TripAdvisior™ search tools or the like, such as for relevant food and lodging reviews that can be coordinated with stops where the carrying case is currently located or along the route detailed in a travel itinerary.

In further aspects, the integration interfaces 1060 can connect to third party systems 1120 through the cloud networking facility 960 or by other connections such as via local interfaces to the third party systems. The information technology services 1070 can connect to third party data services 1130 also through the cloud networking facility 960. The third party data services 1130 can include a wide variety of services that provide or use travel information, such as travel services 1200 like airline booking databases (e.g. Expedia™), hotel booking services (e.g., Hotels.com™), restaurant booking services (e.g., Open Table™), telecom services 1210 (such as from wireless data providers), and data sources that provide various types of travel information or portions thereof in the form of data items as described throughout this disclosure. Travel services may include loyalty programs, reward programs and the like.

In additional aspects, the information technology services 1070 may also connect to a packing guidance module 1300 that can be local to the mobile computing device 900 or through the cloud networking facility 960; that is, the packing guidance module 1300 may be integral to the technology compartment 830 or may be module connected to or accessed through the cloud networking facility 960. In embodiments, the packing guidance module 1300 may access travel information, such as about an upcoming trip, such as based on a user input (e.g., engaging a “prepare for trip” element on a user interface on the carrying case 800, on a user's mobile device 240, or the like), or based on obtaining travel information from one or more external sources (such as receiving an indication that the user of the carrying case 800 has booked a flight, has booked a hotel, has booked a restaurant in a remote location, or has undertaken some other interaction with a travel system that indicates a trip is likely to occur).

In embodiments with reference to Fig. F100, the methods and systems of the present disclosure may thus recognize the creation of a new trip at a step F102, either based on a user's input or based on recognition of information that indicates the likelihood of a new trip. If anew trip has been proposed at the step F102 based on external information, then at a step F104 a user may confirm the new trip, including optionally naming the trip, such as with a destination and a date (e.g., “Vienna, June 2017”).

In embodiments, once a trip has been declared, the carrying case 800 may request that the user enter additional information about the trip at a step F108, such as by prompting the user to enter travel information, including dates, destinations, booking information, and the like. In embodiments, at a step F110, the system may initiate one or more searches for information about the trip, such as based on stored profile information of the user, such as by automatically searching, optionally based on the user's stored credentials (which the system may store with appropriate security features, such as encryption features) various travel information sources for additional data that may be relevant to the trip (such as airline sites, booking sites for travel, accommodations, rental car information, and the like) and optionally searching one or more electronic calendars of the user for other travel information. This may be accomplished by a federated search capability, such as operating a set of parallel web crawlers, scripts, processes, or the like. From the user input at the step F108 and the external collection at the step F110 the methods and systems may obtain information sufficient to determine and store an itinerary for the trip, which may include dates, locations, accommodations, and the like.

At a step F112 a user may be prompted to confirm and/or modify the itinerary, including indicating a purpose for the trip or for one or more components of the trip (e.g., indicating that a meeting is a business meeting). At a step F114, once an itinerary is determined, the system may collect additional travel information, such as weather information, information about travel alerts relevant to the itinerary, and the like. Once an itinerary is determined and additional information is obtained that is relevant to packing for the trip, at a step F118 the packing guidance module may automatically, under computer control generate a packing list, which may be accomplished by applying a set of business rules using a rules engine to the available itinerary data, such as determining a number of outfits to wear based on the duration of the trip, determining the type of outfits based on the location, weather and purpose of the trip (e.g., a business trip to London in February would activate a rule requiring outerwear suitable for rain or snow), and determining other items, such as medications (e.g., anti-malarial drugs for a trip to a destination where a malaria alert was found) and accessories that will be needed. By operating on the itinerary and other travel information from user input and various sources, the packing module thus determines a packing list.

In embodiments, the rules engine may employ or be associated with a packing list intelligence facility, which may employ a variety of technologies and techniques for providing better quality packing lists. These may include collaborative filtering capabilities, such as for determining what a user should pack based on packing lists by other users who have taken similar trips, and machine learning facilities, such as where packing lists are iterated and refined over time based on feedback by one or more users, including the user of the carrying case, such as based on post-trip surveying of user input as to whether the trip was successful, whether items were needed that were not packed, and whether items were packed that were not needed.

In embodiments, the packing guidance module may also connect to and access user profile data that can be stored local on the mobile computing device, on the mobile device, or accessible through the cloud networking facility, and the user profile data may be used to modify the packing list, such as based on one or more rules applied by the packing list rules engine. For example, a user may indicate in a profile a desire to always have an extra outfit for each trip, to have the lightest possible weight that satisfies requirements for the trip, or the like. Thus, through the various steps indicated above, data from the user and other sources can be used to automatically populate a packing list based on a defined travel itinerary. One or more packing lists can be created and stored in the packing guidance module.

Next, at a step F120, the packing guidance module may guide the user through packing on a step-by-step basis, such as indicating what items to collect for packing, what items to place in what part of the carrying case, the recommended order for placing the items, and the like. In embodiments, a packing guidance rules engine may operate on the packing list, optionally accounting for information in a user's profile, such as preferences for how to pack, to determine a packing plan. The packing plan may account for information about the user's current supplies (including levels of consumables), as well as information about items available at a destination (such as, for example, adjusting the packing list based on awareness that a hotel provides certain items, such as workout clothing, so that the items can be omitted from packing and obtained locally at the destination). Where an item on the packing list is omitted from the packing plan at the step F120, then at an optional step F122 the system may initiate a request and/or reminder relating to the item, such as sending a message to a hotel at the destination to provide the item in the traveler's room upon arrival. For items that remain on the packing list, the packing plan may guide the user through the packing process, such as indicating “place waterproof boots in boot bag,” “place three dress shirts in shirt bag,” “place two ties in tie holder,” etc.

The packing plan may be embodied, for example, in a checklist, which may be adapted for display on a touch screen interface 1250 (FIG. 19), such as on the carrying case 800 or on the user's mobile phone, such as allowing the user to indicate an item has been packed (such as by swiping left or right, indicating an “X” in a box, or the like). The packing guidance module may thus guide a user through the packing process, accelerating the process and reducing user anxiety. In embodiments, at a step F124, the packing guidance module may periodically poll the user and one or more external sources for updates, such as indicators of any change in travel information (such as extending the trip, shortening the trip, changing the route, changing accommodations, or the like) that should result in determining and storing a new itinerary. Upon any such updates, the packing list rules engine and packing guidance rules engine may operate on the new itinerary to determine, for example, a revised packing list and a revised packing plan (which may involve identifying additional items to pack, identifying items to unpack, or both). It should be noted that while embodiments describe a single carrying case, the methods and systems disclosed herein may include multiple carrying cases associated with a given user, and packing guidance may include selecting the appropriate carrying case or set of carrying cases that are suitable for a given itinerary.

In accordance with the various aspects of the present teachings, mobile applications 1350 that can be on the mobile device of the user can enable interactions between the mobile device (such as mobile device 240) and the luggage case 800. Content 1360 may be retained in the travel information module 950 or on the mobile device, or both, and can be used to increase engagement with the carrying case 800. The content 1360 may include personalized content 1370, social content 1380, and the like. In doing so, the travel information module 950 can create and retain content, user filters, user profiles, and can interact with social media. Moreover, the content can include loyalty programs and rewards information and social games that can track progress through travel itinerary, like checking into intermediate and final destinations.

Referring to Fig. G100, the methods and systems disclosed herein may include an intelligent trip itinerary module 1400 that can be used to develop itineraries for one or more trips. As noted above in connection with the packing guidance module, at a step G102 the possibility of a new trip can be recognized based on user input or based on periodically polling services and accounts of a user to identify one or more indicators of a trip, such as a new booking of a flight, a hotel, a restaurant, a rental car, or the like. A user can confirm the existence of a trip at a step G104. Where the itinerary is sufficiently well developed, the system may proceed to developing a packing list and packing guidance; however, in some cases the user may require assistance in developing the itinerary. In such cases, at a step G108, the methods and systems disclosed herein may solicit and accept general information about the itinerary from the user, such as at least one location and date ranges for possible travel, as well as an indicator of the budget for the trip.

At a step G110 the user may be prompted to label the trip, at which point the system may track it as an identified trip, such as with a unique identifier. Once a trip is identified, the system may, at a step G112, similar to the techniques noted above, crawl external sources and the user's accounts (including travel sites, calendar, email, and the like), for indicators of additional information about the itinerary. For example, the system might find “business trip to Vienna” for a set of dates and “vacation” for a set of other contiguous dates, both of which might be associated with a multi-purpose trip. At a step G114, once some parameters for an itinerary are known, the system may undertake searches for additional travel information that could be used to complete the itinerary, such as information about possible routes and destinations, information about points of interest, information about promotions and offers, information about events, information about accommodations, information about weather, and many others.

At a step G116, the system may employ an intelligent itinerary development rules engine 1500 to expand on the itinerary. The itinerary development rules engine may, for example, apply a set of business rules on the travel information obtain at the step GI 14 and on information obtained and stored at other steps, including information about the user's profile, to propose options for the itinerary. For example, if there is determined to be an unplanned day for a trip, the itinerary development rules engine may propose, based on the user's profile, a location and an activity that is compatible with the current parameters for a trip and that corresponds to a “wish list” by the user or an element of the user's profile that suggests the activity would be good for the user, such as to see a particular type of event or visit a particular type of destination. The rules engine may employ or be used in connection with various techniques and tools for intelligence, such as using similarity analysis to profiles of other users (such as for collaborative filtering to determine proposed items on an itinerary) and using machine learning (such as to improve recommendations over time based on feedback from the user and from other users).

At a step G118, a user may provide input on suggested options for the itinerary, such as to opt-in to certain events, destinations, or the like. At a step G120, once a user has opted into an itinerary, the system may undertake, by executing rules in the itinerary planning rules engine, various actions to initiate portions of the itinerary, such as by automatically, using the user's stored credentials, reserving flights, trains, buses, cruises, and the like, booking rooms, booking meals, booking rental cars, and the like. The process can undertake a series of iterations of the preceding steps, such as sequentially offering additional more detailed options as high-level elements are locked in to an itinerary, until the itinerary is complete. At a step G122, the system can periodically poll for updates, such as changes in reservation information, changes in weather, changes in dates, and the like, and, based on identified changes, can iterate through the aforementioned steps to produce a revised itinerary based on the updated information.

In embodiments and with reference to FIG. H100, the carrying case 800 may include an intelligent trip guidance module H100 for guiding a user through a trip. The trip guidance module may take as inputs information about a planned itinerary, information about what has been packed for a trip, information about the user (including user profile information), user inputs, and inputs from external sources, such as data sources about travel information as noted throughout this disclosure and information from external systems with which the carrying case 800 interacts using its communications facilities. The trip guidance module may comprise various components, modules and services that may be deployed and distributed in various configurations on the computing device 900 of the carrying case 800, in the cloud, on a user's mobile device, and/or on one or more other external systems.

The trip guidance module may include an intelligent routing module H102 for routing the user to the next step in the itinerary, such as directing the user to the right counter for check-in, to the right line (such as for airport security), or to the right accommodation, event, or the like. The intelligent routing module may apply various rules to the various inputs described above to determine a next routing instruction to the user. For example, if the user has indicated via user input that the user is hungry, the routing module can determine a route to a nearby source of food, such as a restaurant counter in an airport, where the food is selected based on a user's profile, such as through collaborative filtering with similar users or based on a user's expressed preferences for a particular type of restaurant. Machine learning may be used to improve routing over time based on feedback of the user or other users.

The trip guidance module may also help the user navigate various elements of the trip, such as dealing with logistics of an airport. For example, the trip guidance module may, at a step H104, relay information directly to infrastructure elements at an airport, such as relaying information via the information technology infrastructure of the airport, such as to check in the user to a flight, to instruct a kiosk to print a boarding pass, to present a boarding pass for the user (such as displayed on the user interface display 950 (FIG. 19) of the carrying case 800), or the like. The trip guidance module may provide the user other instructions at step H108, such as instructions for what items to unpack at what time (e.g., instructions how and when to remove a modular computing device 900 to pass through airport security systems, or instructions as to what items to unpack when arriving at a hotel), instructions what additional items may need to be obtained and where to get them (such as items that are needed as a result of updates to the itinerary), instructions how to communicate in a local language, or the like.

The trip guidance module may at a step H110 provide information to external systems to help with guidance or provision of services, such as informing an airline or other carrier where the carrying case is located, providing an estimated time of arrival to a carrier or accommodations provider, providing advance indications of a traveler's needs, and the like. For example, upon determining that the traveler is hungry (or is likely to be hungry), the carrying case 800 may order food (such as from a food service facility located at a terminal) and request that it be delivered for stocking on an aircraft or other vehicle, allowing the traveler's nutritional needs to be met during times when layover times are insufficient to allow for a meal between legs of travel. The traveler may receive updates on the carrying case, via a mobile device, or the like indicating options for such services and providing information about them. The computing device 900 may store account information, credentials, and the like for the traveler, with appropriate security mechanisms, to enable purchasing and other e-commerce activities to be undertaken on behalf of the user directly from the carrying case 800.

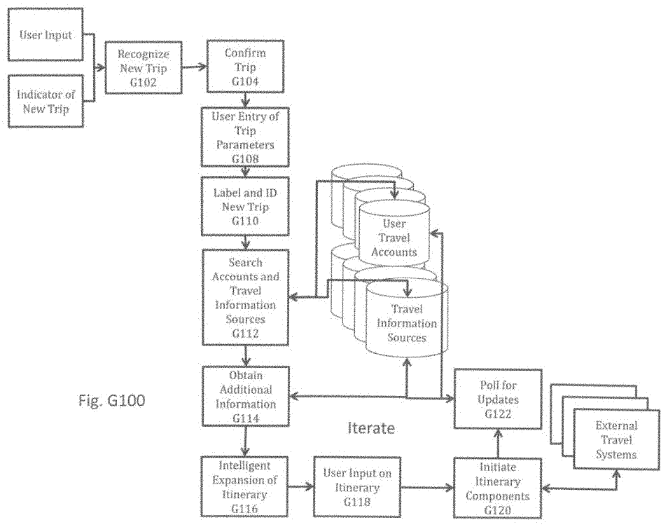

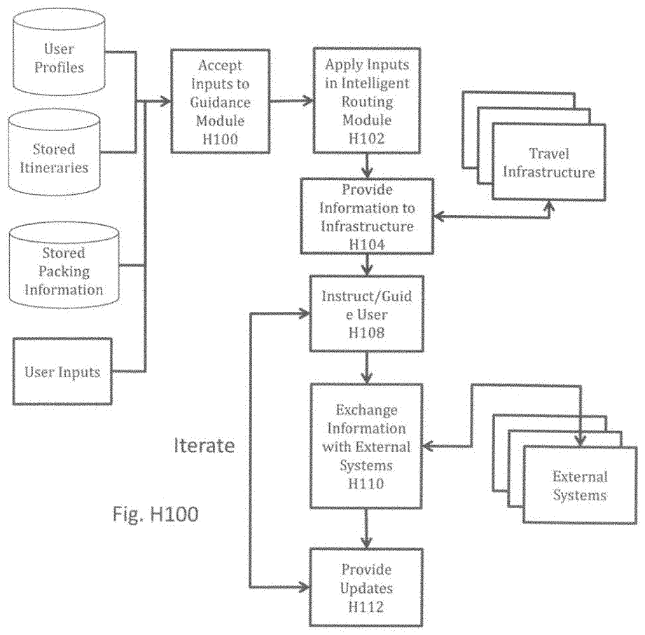

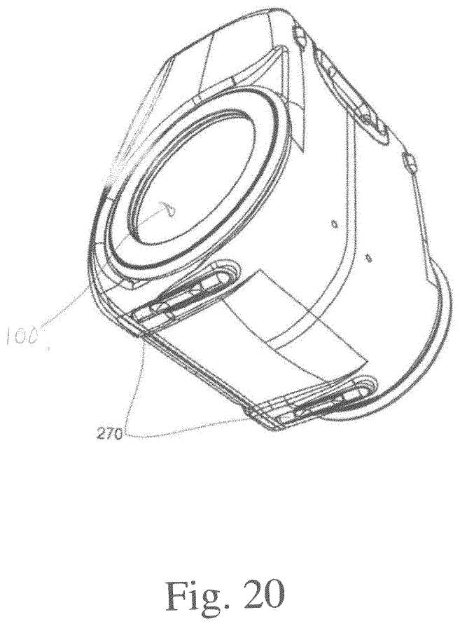

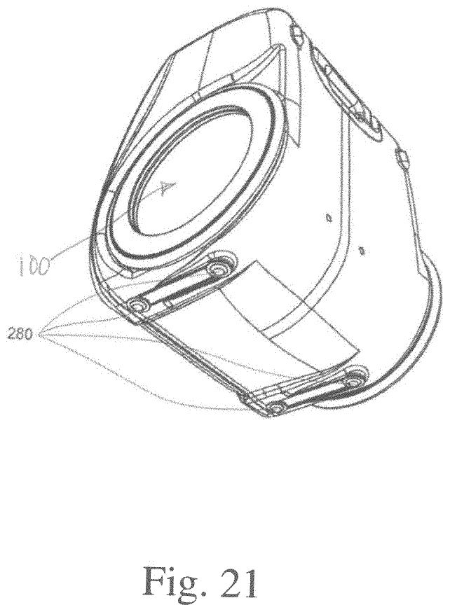

Reference is now made to FIGS. 20 and 21 presenting alternative embodiments of the present invention. In FIG. 20, supporting members 270 provide a steady upright position of the wheeled luggage case. According to FIG. 21, the luggage case is movable in the upright position on ball bearing supporting members 280 along the ground surface.

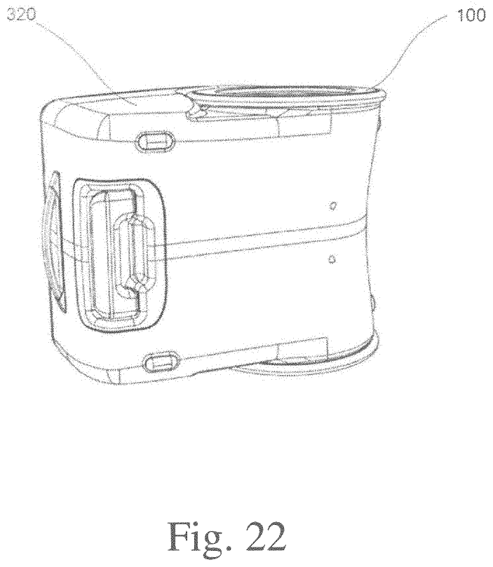

Reference is now made to FIG. 22, illustrating an option of placing the luggage case side along on the axle-free wheel. It should be emphasized that the axle-free wheel 100 is flush-mounted with the side wall 320.

Reference is now made to FIGS. 23a-23c illustrating a further embodiment of the present invention. The wheeled luggage case comprises a main housing 380 and a covering member 390 interconnected by a connecting mechanism 395 limiting opening the covering member 390.

Reference is now made to FIGS. 24a and 24b, presenting partitioned by at least one divider 400. Compartmentalization of the luggage case provides additional convenience to the user. In further aspects, the main compartment can be sectioned by the divider 400.

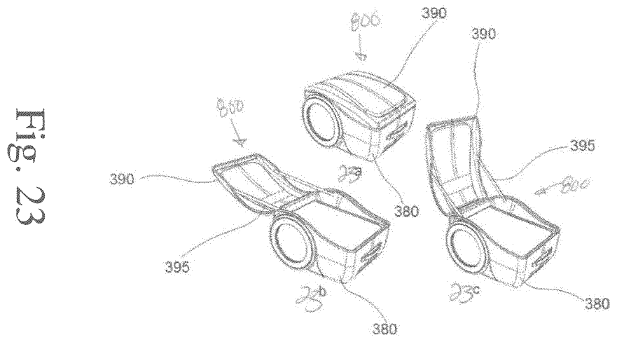

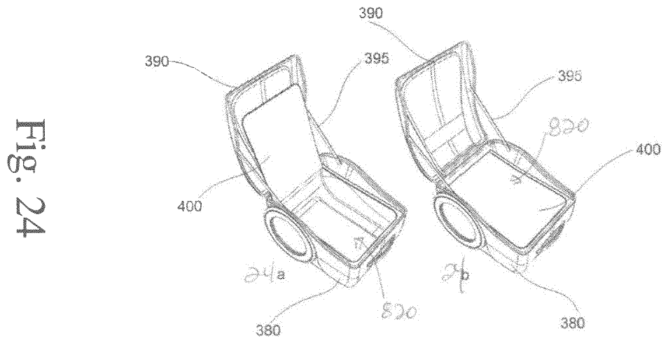

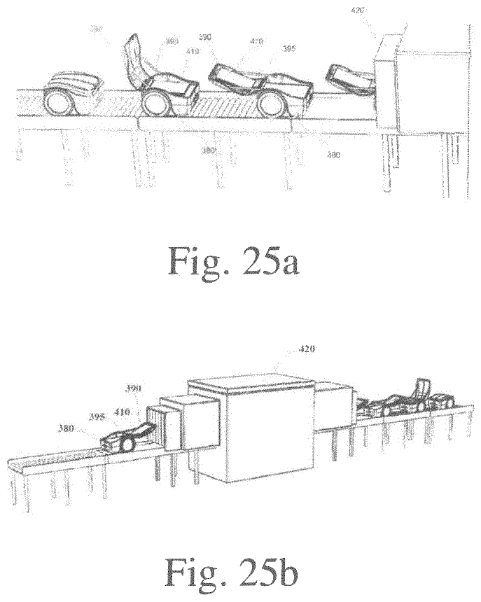

Reference is now made to FIGS. 25a and 25b illustrating an X-ray security procedure. The wheeled luggage case of the present invention provides an additional option of security check in opened position in an X-ray check machine 420. Specifically, a portable computer 410 or other mobile device may be placed in the main hosing 380 or in the covering member 390 in a position open for any inspection.

In further aspects, the luggage case can be configured to allow for relatively quick flow through airport security. The technology compartment can be configured to be removable from the housing and then immediately replaced back into the housing after security. A docking connector mechanism in the housing and in the technology compartment can be configured to make a one connector connection to make the removal and reinstallation of the technology compartment relatively easy. In further aspects, the technology compartment can have multiple components or pods that can be dissembled from the technology compartment and inspected by airport security. After airport security, the pods can be connected back into a technology pack (i.e., the assembled pods) that can be placed the technology compartment. By way of this example, the technology compartment can be fixed in the housing and the technology pack can be removably connected from the technology compartment. In other examples, the technology compartment can be a sub-housing that is removable from the housing allowing for a single unit to be replaced, inspected, or replaced.

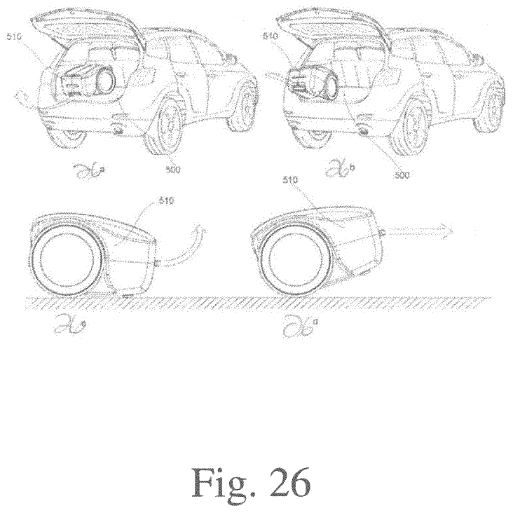

Reference is now made to FIGS. 26a-26d illustrating withdrawal a wheeled luggage case 510 from a car trunk 500. It should be emphasized that the case 510 possesses additional convenience when it is placed into and withdrawn from the car trunk 500. Specifically, when a portion of the case 510 provided with a handle is slightly raised (see FIGS. 25a and 25c), the case 510 is easily moved on the wheels (FIGS. 25b and 25d).

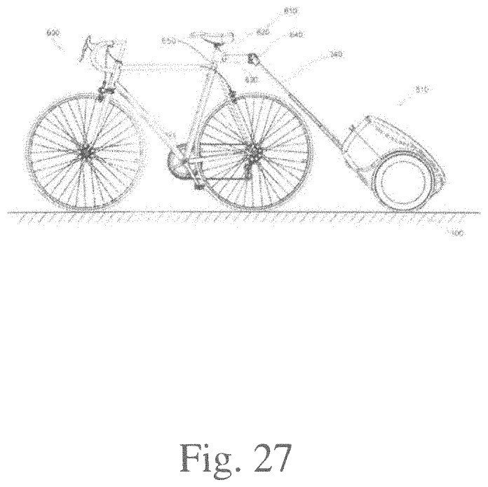

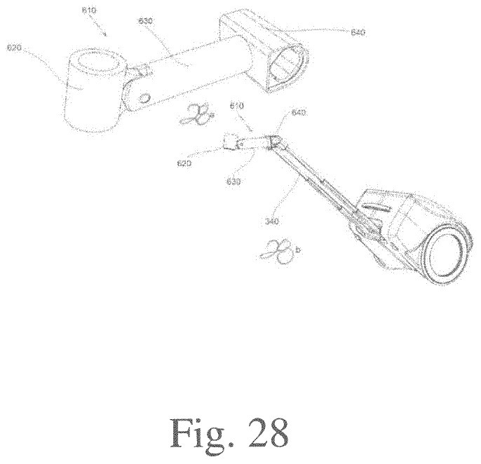

Reference is now made to FIGS. 27, 28a and 28b, presenting an embodiment of the present invention configured for a towing case 510 with a bicycle 600. Specifically, the case 510 is mechanically connected to the bicycle 600 with an adapter mechanism 610 comprising a clamp 620 embracing a seat post 650 of the bicycle 600, a clamp 640 embracing the telescopically protrudable handle 340 and a rigid link 630 interconnecting clamps 620 and 640.

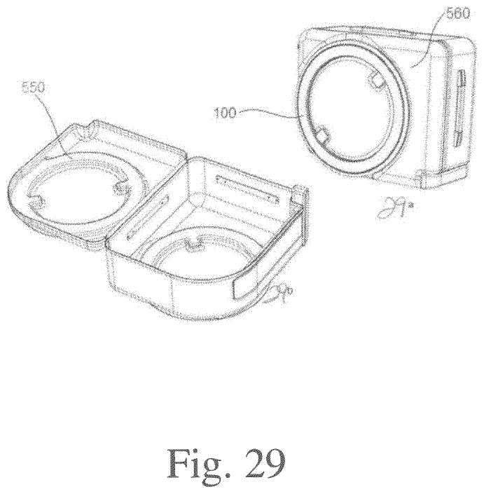

Reference is now made to FIGS. 29a and 29b presenting a book-like openable case in close and open positions, respectively. In order to decrease a lateral dimension of the wheeled case of the present invention, the axle-free wheels 100 are mounted within a slot 550 (shown from backside) flush with a side wall 560.

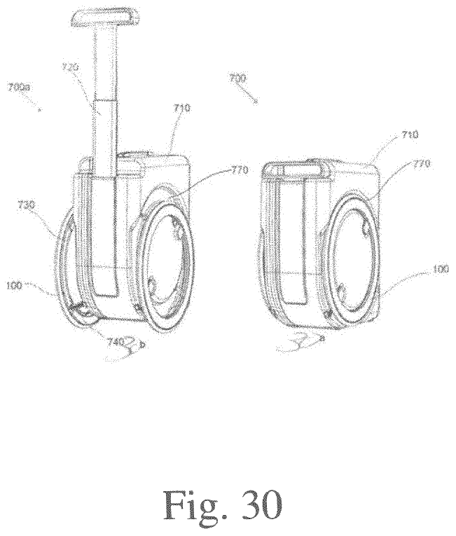

Reference is now made to FIGS. 30a and 30b, presenting an embodiment of the present invention provided with a deploying mechanism. According to this embodiment, the deploying mechanism has a collapsed position and a deployed position shown in FIGS. 30a and 30b, respectively. Specifically, in FIG. 30a, the case 700 is characterized by the axle-free wheels 100 sunk within a slots 770 in the case 710 which corresponds to a collapsed position of the deploying mechanism. In the collapsed position, there is no mechanical contact of the axle-free wheels 100 with the ground surface. Contrary to the collapsed position, in a deployed position, the axle-free wheels 100 are protruded from the slots 770 such that the wheels contact with the ground surface.

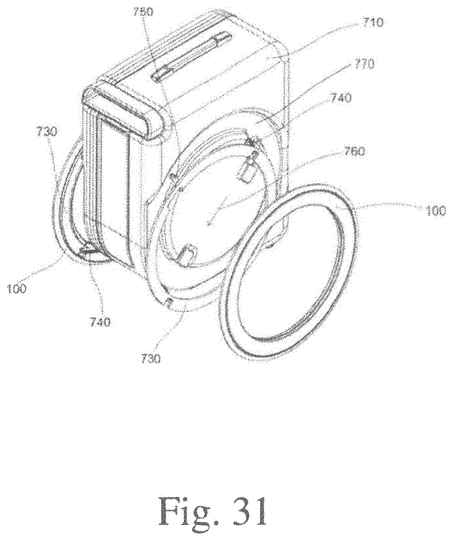

Reference is now made to FIG. 31, presenting an exploded view of the wheeled case in a deployed position. The deploying mechanism comprises an annular member 730 configured for mechanically attaching the labyrinth axle-free wheel 100. At least two lever arms 740 hingedly interconnect the member 730 and the slot 770 of the case.

Auxiliary arms 750 provide mechanical stability at the deployed position. As seen from FIGS. 29 (a, b) and 30, the lever arms 740 have a first steady position parallel to the slot 770 of the case 710 (collapsed position) and a second steady position in which the arms 740 are rotated by an obtuse angle (deployed position) relative to the first position.

Numeral 760 refers to a direction of deploying the axle-free wheel 100 such that the wheels are able to support the case 710 relative to the ground surface (not shown).

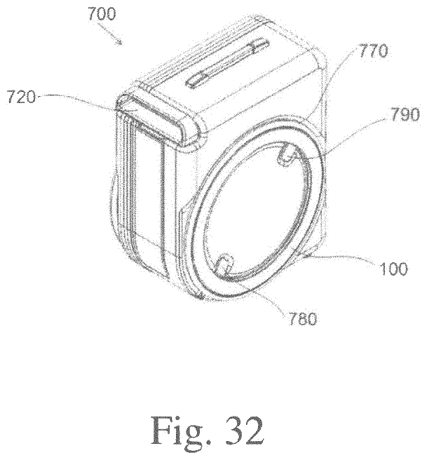

Reference is now made to FIG. 32, illustrating a procedure of deploying the axle-free wheels 100 from the wheeled case 700. Specifically, a handle 790 is designed for pulling-out the aforesaid wheel 100 from the slot 770 manually. A swinging locking mechanism 780 keeps the wheel 100 in collapsed position (sunk within the slot 770) in a main position in parallel to case wall. The wheel 100 is released when the locking mechanism 780 is manually tilted as shown in FIG. 32. It should be emphasized that the aforesaid swinging locking mechanism are configured for reliably fixating in the abovementioned collapsed and deployed positions. Additionally, fixation of in any intermediate position between the collapsed and deployed positions is in the scope of the present invention.

Further aspects of the present teachings include the packing guidance module connected with the mobile device and the user behavior data module in travel information module 950 in the mobile computing device of the technology compartment. The packing guidance module can also access travel itinerary data. The packing guidance module can also connect with the main compartment to monitor completion of the packing process.

By way of the above example, the travel information module 950 can learn from the user that the travel itinerary is three-day business visit to southern, warmer area of a country. The travel information can determine the weather the destination and it looks to be for example 90° F. (about 32° C.) during the day and early evening. Based on the user information data, the travel information module 950 can suggest to the user certain items to pack such as sunscreen and a change of clothes that can be lighter in weight because of the weather. The information unit can also query the user through the mobile device to establish a user profile and further determine what outfits or sets of clothes the user may wish to take on the trip. The packing guidance module can suggest packing lists based on the days of travel such as undergarments. The packing guidance module can also suggest bring less garments when the travel itinerary indicates laundry facilities being available in the travel itinerary for relatively longer trips. The packing guidance module can receive input from the user about predetermined packing pod for example “business suit pod.” The user can define what is included in the business suit pod and when the user completes packing of the pod, the travel information module 950 can confirm the business suit pod has been added to the main compartment.

In certain aspects of the present teachings, the main compartment can when certain items of clothing or the business suit pod are packed. In some examples, each piece of clothing could have a magnetic or radio tag, so when the garment is loaded the travel information module 950 detects and logs the packing of the clothing. In further examples, the main compartment can have a load cell to determine certain items are packed. In other instances, the user can simply check off each item as it is packed into the main compartment.

In yet another example, the main compartment or individual pods in the main compartment can have individual receptacles that can receive certain article of clothing. For example, the pod that can be dedicated to a business suit can have compartments for two neckties. By way of this example, when the neckties are loaded into the two compartments, the business suit pod can sense the ties in location and when the pod is loaded into the main compartment, the packing guidance module can determine that the neckties have indeed been packed. In further examples, when the neckties are loaded into the two compartments in the main compartment, the packing guidance module can determine that the neckties had indeed been packed.

In additional examples, the packing guidance module can determine a packing list after the user has manually packed the main compartment. At that point, the travel information module 950 can scan and learn the clothing and items in the main compartment to build a packing list and store it in the packing guidance module. In further examples, the travel information module 950 can poll the user about what has been packed or even packed in the past to build a packing.

In yet further aspects of the present teachings, the user can establish a packing list for fast departures. These fast departure packing lists can include essentials such as toiletries, medicines, glasses, charge cords, and the like, Using the fast departure packing lists, the user can set small format packing list, or punch list, so as to not forget anything in a quick departure scenario. The punch list could include a top five or top ten items that cannot be forgotten before travel such as medicines, glasses, passport, and the like. In further examples, the packing guidance module can break down the total packing list into smaller to do lists or topical punch lists. These to do lists or punch lists can include many “packing missions” that each can take much less time but when all completed can complete the total packing list.

In yet further aspects of the present teachings, the travel information module 950 take relevant itinerary detail from Expedia, the Weather Channel and the like to determine the duration of the trip, durations of intermediate segments (e.g.: plane and train legs), intermediate or final destinations (e.g.: any hotel booking), the weather along your journey, and how long your total trip is, and the like. In various examples, the travel information module 950 can make suggestions to the packing guidance module based on the travel itinerary to include or exclude items. For example, the travel itinerary can include a hotel that has a pool and a workout facility. The travel information module 950 can add swim wear and workout wear and items to the itinerary. The information from Expedia or other travel sites can be used by the travel information module 950 to remove items from the packing list. In this example, the hotel workout facility can indicate that it provides workout wear. As such, the packing guidance module can omit these items from the packing list and inform the user of items available at the destination. To that same end, the user data can be used by the travel information module 950 to transfer information back to the destination about the user. In this example, the travel information module 950 of the luggage case can reserve workout clothes at the hotel on the travel itinerary based on the size of the user. In further aspects, the travel information module 950 can make suggestions to the user to save time. In one example, the travel information module 950 can make suggestions about shorter paths to the airport. In further examples, the travel information module 950 can make suggestions about earlier leaving connecting flights when the travel information module 950 recognizes the user is in the midst of a layover on the travel itinerary.

The various embodiments of the present invention can be characterized by the following technical features:

The present embodiment is configured as a book-like openable case.

The axle-free wheels in a collapsible position are sunk within the wall slots of the case.

The axle-free wheels can be drawn out of the wall slots into a deployed position such that a wheel is enlarged in comparison with a case dimension to prevent the case from rocking or overturning when used.

In accordance with the present invention, a labyrinth axle-free wheel is disclosed. The aforesaid wheel comprises (a) an internal rim; (b) an external rim provided with a ground interface; (c) rollers being rotatably disposed within a roller spacer between the internal and external rims in a uniform circumferential manner with a spacer; and (d) external covers.

It is a feature of the invention to provide a labyrinth dust passage defined by the rims and the external plates mechanically connected to the internal rim.

In accordance with further embodiments of the present invention, at least one of the rims is provided with dust chambers circumferentially distributed over the rim, the rollers are disposed within a roller spacer having two side planar annular members, and the members are provided with dust chambers circumferentially distributed thereover.

In accordance with other embodiments of the present invention, the annular members are interconnected with pintles circumferentially distributed over the member which carry the rollers. At least one roller is provided with at least one a dust-gathering groove. The external covers are provided with at least one dust chamber circumferentially distributed over the cover.

In further embodiments, a wheeled luggage case comprises: (a) a storage chamber; (b) a cover defining an opening on at least one side of the storage chamber for providing ready access therein; and at least two labyrinth axle-free wheels operatively connected to the chamber for towing the case along a ground, surface. Flooring, stairs and other types of the surfaces are in the scope of the present invention.

In accordance with other embodiments of the present invention, the case comprises an electric generator kinematically linked to the wheel configured for energizing a load connectable to the generator. The case also comprises a chargeable internal battery. The case also comprises an internal compartment configured for accommodating the battery therewithin.

In further embodiments of the present invention, the case comprises at least one ball bearing configured for supporting and moving the case in an upright position.

In yet further embodiments, the case comprises an embedded control unit configured for controlling at least one parameter selected from the group consisting of battery charging, internal temperature and cooler operation. The case also comprises a display configured to display parameters controlled by the controller. The case additionally has two covering flaps openable in opposite directions. The case can be also provided with at least one external light configured for illuminating a user's path and enhancing safety thereof. The case is provided with at least one internal light configured for illuminating an internal space of the case. The chamber is made of a translucent material and the case further comprises an internal lighting mechanism configured for change in color of the case.

In accordance with yet further embodiments of the present invention, the case comprises a telescopically protrudable handle. The telescopically protrudable handle is radially configured.

In other embodiments, the control unit comprises a GPS chip, an RFID chip and/or a USB interface and other communication port. The case also comprises cooling mechanism controlled by the control unit.

In accordance with further embodiments, the case comprises an expansion mechanism configured for gaining a volume of the case. The expansion mechanism is selected from the group consisting of a telescopic member embedded into the frame, a spring-loaded member and any combination thereof.

In accordance with additional embodiments, the case comprises at least one internal compartment configured for accommodating a specific kind of articles. The compartment is marked with a symbol identifying the specific kind of articles. The case comprises at least one adjustable connecting mechanism configured for holding user's articles within the compartment. The case comprises an adapter for towing with a bicycle. The adapter comprises a clamp embracing a frame of the bicycle, a clamp embracing the telescopically protrudable handle and a rigid link therebetween.

In accordance many embodiments, the two labyrinth axle-free wheels are mounted flush with side wall of the case. Each of the labyrinth axle-free wheels is provided with a deploying mechanism having a collapsed position and a deployed position. The deploying mechanism comprises an annular member configured for attaching the labyrinth axle-free wheel and lever arms hingedly interconnecting the member and the side wall of the case. Lever arms have a first steady position parallel to the side wall of the case and a second steady position in which the arms are rotated by an obtuse angle with the first position.

The present teachings include a carrying case that offers connectivity and versatility to a user. The carrying case can include a housing of the carrying case having a main compartment and at least one technology compartment. The housing can be configured to have a closed position and an open position that provides access to the main compartment for placement and removal of items in the carrying case. A mobile computing device can be contained in the at least one technology compartment. The mobile computing device can be configured to store at least one identifier for the user of the carrying case. A travel information module can be associated with the mobile computing device to receive travel information of the user based on the at least one identifier of the user. The travel information can include at least one itinerary data item of the user.

In additional embodiments, the present teachings include a packing guidance module associated with the at least one identifier of the user and with the mobile computing device. The packing guidance module being can be configured to generate a packing list based on the travel information and based on packing information associated with a capacity of the main compartment. The present teachings also include the housing that can contain an interface for the mobile computing device that is configured to receive a portion of the travel information from the user. The present teachings further include the interface that includes at least one of an application programming interface and a network interface for receiving the portion of the travel information related to the user from a remote computer. The mobile computing device can be configured to receive a portion of the travel information from a mobile device of the user. The user can enter the portion of the travel information in an application on the user's mobile device that is associated with the carrying case via the at least one identifier of the user.

In additional embodiments, the present teachings include travel information module being configured to connect to external sources and receive a portion of the travel information related to the user through the external sources. The external sources can include providers of travel services and the portion of the travel information can include information associated with the user and the at least one itinerary data item about at least one of a flight, a hotel, a restaurant, a rental car, a train, a bus, an event, a ticket, a reservation, a schedule, a location, a meeting, an activity, weather information, and a travel alert. The packing information can include the capacity of the main compartment and the packing list is based on the capacity.

In yet further embodiments, the present teachings include the packing information that includes a capability of the main compartment and the packing list is based on the capability. The capability can be at least one of a garment bag capability, a shoe bag capability, a toiletries case capability, a tie container capability, a make-up case capability, a shirt container capability, a suit holder capability, a dress holder capability, an accessories holder capability, an underwear holder capability and a hosiery holder capability. The packing list can be color coded to correspond to colors of at least one of the capabilities. In additional embodiments, the present teachings can include an additional carrying case defining a capacity. The packing list can be based on the capacity of the main compartment and the capacity of the additional carrying case.

In additional embodiments, the present teachings include the packing guidance module that can be configured to query the user through at least one of the interface on the housing and an application on the user's mobile device. The packing guidance module can be configured to receive from the user at least one of identification of an itinerary, dates of travel, a destination, and booking information relevant to the itinerary data item.

In additional embodiments, the present teachings include the mobile computing device of the carrying case. Upon receiving information, the mobile computing device can initiate a search for additional information related to at least one of the user and the itinerary data item. The search can use the at least one identifier of the user to search at least one travel service of the user for information related to the at least one itinerary data item and associated with at least one account of the user associated with the at least one travel service. Results of the search can be used by the packing guidance module to further configure the packing list. The query to the user can include one of confirming a portion of the travel information, modifying a portion of the travel information, and indicating a purpose for travel.

In yet further embodiments, the present teachings include the packing guidance module including a rules engine that applies a set of rules to generate a packing list including at least one of determining a number of outfits to pack based on the at least on itinerary data item, determining types of outfits to pack based on a destination associated with the at least one itinerary data item, determining types of outfits to pack based on weather at the destination associated with the at least one itinerary data item, determining types of sunscreen to pack based on the weather at the destination associated with the at least one itinerary data item, determining types of outfits to pack based on a purpose of the itinerary data item, and determining medications to pack based on the destination associated with the at least one itinerary data item. The travel information module can include travel information based on a profile of the user. The profile of the user can be based on at least one of information entered by the user in response to queries in an interface of at least one of the mobile computing device, a mobile device of the user, and a browser used by the user; information obtained by tracking the usage of the carrying case by the user over a period of time; and information inferred based on similarity of at least one of the user and usage of information related to other users.

In yet additional embodiments, the present teachings include a packing guidance module associated with the mobile computing device. The packing guidance module can use the travel information, the user profile information, and information about the carrying case to produce a packing list for the user related to the at least one itinerary data item. The present teachings can include a packing list intelligence facility connected to the packing guidance module that can amend the packing list based on one of packing lists by other users who have taken trips similar to those associated with the at least one itinerary data item, feedback by at least one of the other users, and feedback by the user. The present teachings can also include a packing list intelligence facility connected to the packing guidance module that amends the packing list based on feedback by the user including one of a post-trip survey to the user, and querying the user to determine whether items on the packing were needed or not needed. The present teachings can further include user profile data connected to the packing guidance module that can be configured to amend the packing list based on one of a desire detailed in the user profile to always have an extra outfit for each trip, and a desire detailed in the user profile to minimize a weight of the carrying case while packing the packing list in its entirety.

In further embodiments, the present teachings include the packing guidance module being configured to instruct the user including one of indicating items on the packing list to collect for packing in the main compartment, indicating in what part of the main compartment items from the packing list are to be placed, and indicating a recommended order for packing items from the packing list into the main compartment. The packing guidance module can be configured to track levels of remaining quantities of consumables listed on the packing list and indicate to the user when replenishment of the consumables is needed. The packing guidance module can be configured to obtain information about at least one item available from at least one destination associated with the itinerary data item and alter the packing list to omit an item based on the at least one item available at the destination. The packing guidance module can be configured to instruct the mobile computing device to pre-order at least one item available from the at least one destination associated with the itinerary data item for availability of the at least one item upon arrival of the user. In further embodiments, the travel information module can transmit a request to a hotel associated with the at least one destination associated with the at least one itinerary data item to confirm whether the at least one item is available at the at least one destination and whether to omit the at least one item on the packing list based on the request about the at least on item being available at the at least one destination. The request from the travel information module can include sending a message to a hotel at the at least one destination to request that the at least one item at the destination be placed in a room at the hotel for the user.

In additional embodiments, the packing list can be a checklist displayed on an interface on one of the carrying case and a mobile device of the user. The interface can be configured to receive at least one of an input from the user and a sensor input that indicates that an item has been packed in the carrying case. The travel information module can be configured to connect to at least one third party service to obtain updates to the travel information of the user. The travel information module can be configured to connect to at least one third party service to obtain updates to the travel information of the user. The packing guidance module can be configured to generate a revised packing list based on any relevant changes to the travel information. The travel information module can be configured to compare the packing list to the revised packing list and indicate instructions to the user including one of identifying additional items to pack and identifying items to unpack.

In further embodiments, the packing guidance module can indicate to the user to obtain an additional carrying case based on the packing list. The travel information module can monitor the main compartment to determine a percentage indicative of how full the main compartment is. The percentage can be available via at least one of an application programming interface, an interface on the carrying case, and an interface of an application on a mobile device of the user. In additional embodiments, the present teachings can include a predetermined packing pod configured to be contained with the main compartment when the housing is in the closed position. The predetermined packing pod can include assigned locations for items. The packing guidance module can monitor the predetermined packing pod to determine when the items are secured in the assigned locations and indicate to the user through an interface completion of a portion of the packing list based on the items secured in the assigned locations and when the predetermined packing pod is secured in the main compartment. The packing guidance module can be configured to generate a fast departure packing list based on one of essential items predetermined by user, a user profile, and at least one destination associated with the travel information. The packing guidance module can be configured to break up the packing list into multiple small format lists. The travel information module can display one of the small format lists after completion of another of the small format lists.

In additional embodiments, the travel information can include a hotel. The packing guidance module can include a suggestion for a swimsuit in the packing list when the travel information module determines the hotel includes a pool. In further embodiments, the travel information can include a hotel and the packing guidance module can include a suggestion for removing workout wear in the packing list when the travel information module determines the hotel includes a workout facility that provides workout wear to its guests. The travel information module can be configured to send a reservation for workout wear to the booked hotel when the user omits the workout wear noted in the suggestion.

In yet further embodiments, the present teachings include a carrying case that offers connectivity and versatility to a user. The carrying case includes a housing of the carrying case having a main compartment and at least one technology compartment. The housing can be configured have a closed position and an open position that provides access to the main compartment. A mobile computing device can be contained in the at least one technology compartment. The mobile computing device can be configured to handle an identifier of the user that associates the user with the carrying case and configured to have at least one of an application programming interface, an interface on the housing of the carrying case, and an interface that is capable of accepting input from an application on a mobile device, such that the mobile computing device facilitates communications from the user and communications with at least one of technology modules of the carrying case and technology resources that are external to the carrying case. A travel information module can be associated with the mobile computing device to receive travel information of the user including itinerary information associated with the identifier of the user.

In additional embodiments, the present teachings include a technology topology that can include wired and wireless connections that deliver and receive electrical power and data connections. The technology topology can include wired and wireless connections using at least one of cellular communications, wired network communications, internet communications, Ethernet, WiFi, BlueTooth. NFC, Zigbee, fiber optic communications, and cable communications. The technology topology can include wired and wireless connections that exchange information between the mobile computing device of the carrying case and at least one of a cloud-based system, the mobile device, an infrastructure of an airport terminal, and an infrastructure of an airplane. The travel information module can be configured to connect to application programming interfaces, integration interfaces, and information technology services that are one of local to the mobile computing device in the technology compartment of the luggage case, and external and accessed through connectivity through a cloud networking facility. The programming interfaces, integration interfaces, and information technology services can be configured to connect to third party applications and provide information relevant to the itinerary information including one of airline booking databases, hotel booking services, restaurant booking services, and telecom services.

In further embodiments, the travel information module 950 can be configured to interact with social content 1600 from social media with retained content 1610 from the user. Social media can include one of loyalty programs, rewards programs, and social games that can detail progress based on the itinerary information. The travel information module 950 can be configured to add destinations to the itinerary information based on input from the user. Input from the user can include one of destinations, date ranges for travel, and budget. The travel information module can be configured to add destinations to the itinerary information based on information from one of possible routes and destinations, points of interest, promotions and offers, events, accommodations, and weather. The travel information module can also be configured to add destinations to the itinerary information based on an intelligent itinerary development rules engine that suggests destinations to add to the itinerary information based on one of a profile of the user, a location and an activity that is compatible with the trip information and that corresponds to a wish list by the user, and a detail in a profile of the user that suggests the activity would be good for the user.

In yet further embodiments, the present teachings include the mobile computing device that can include an intelligent trip guidance module that is configured to route the user to a next step in the itinerary based on the travel information including directing the user to at least one of a correct counter for check-in, a correct security line, a hotel, and an event. The mobile computing device can include an intelligent trip guidance module that is configured to route the user to a nearby source of food when the user has indicated via an interface that the user is hungry. The mobile computing device can include an intelligent trip guidance module that is configured to establish an order for food for delivery to the user when directed by the user through an interface. The intelligent trip guidance module can be configured to order food for delivery to the user during a layover detailed in the itinerary information.

In additional embodiments, the present teachings include a carrying case that offers connectivity and versatility to a user. The carrying case includes a housing of the carrying case having a main compartment and at least one removable technology compartment. The housing can be configured to have a closed position and an open position that provides access to the main compartment and permits the removal of the technology compartment. A mobile computing device can be contained in the technology compartment having a travel information module that is configured to connect to a mobile device of the user. The technology compartment can connect to the housing with a single connecter. The technology compartment can include a plurality of technology pods that can be individually dissembled from the technology compartment and each re-connected back into the technology compartment.

In yet further embodiments, the present teachings include a carrying case that offers connectivity and versatility to a user. The carrying case includes a housing having a closed condition and an open condition that provides access to a main compartment and a technology compartment. A pair of axle-free wheels can be mounted to the housing. A mobile computing device contained in the technology compartment can have an information module that can be configured to connect to a mobile connected device of the user to exchange data associated with the carrying case. The technology compartment can include a power bus. The axle-less wheels are connected to a motor. The motor can draw power from the wheels for generation of power to power the mobile computing device over the power bus. The motor can be used to power the motion of the carrying case. The carrying case can be at least one of user-steered, self-driving, and semi-independent driving. The carrying case can be steered at least in part by connection to a mobile device of the user.

In additional embodiments, the technology compartment can include a data bus to connect the mobile device of the user to the mobile computing device in the technology compartment using at least one of a wireless connection and a wired connection. The data bus can be a universal serial bus. The mobile computing device in the carrying case can be configured to contact services through a cloud network facility to obtain information about the travel itinerary and send up-to-date packing information to a packing guidance module connected with the travel information module based on the information from the travel service. The mobile computing device in the carrying case can be configured to contact a weather service through a cloud network facility to obtain information about the travel itinerary and send amended packing information to a packing guidance module connected with the travel information module based on the information from the weather service. The carrying case can be one of user steered, semi-independent, and self-drive and directed by connected device.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure. All documents referenced herein are hereby incorporated by reference.

What is claimed is:

1.-75. (canceled)

76. A carrying case that offers connectivity and versatility to a user and is configured with a main compartment accessible for items, the carrying case comprising:
a housing of the carrying case containing at least one technology compartment including a mobile computing device configured to store at least one identifier for the user of the carrying case; and
a travel information module associated with the mobile computing device to receive travel information of the user based on the at least one identifier of the user, the travel information including at least one itinerary data item of the user.

77. The carrying case of claim 76 further comprising a packing guidance module associated with the at least one identifier of the user and with the mobile computing device, wherein the packing guidance module is configured to generate a packing list based on a combination of the travel information and packing information associated with a capacity of the main compartment.

78. The carrying case of claim 76 wherein the housing includes an interface for the mobile computing device that is configured to receive a portion of the travel information from the user, wherein the interface includes at least one of an application programming interface and a network interface for receiving the portion of the travel information related to the user from a remote computer.

79. The carrying case of claim 76 wherein the travel information module is configured to connect to external sources and receive a portion of the travel information related to the user through the external sources, wherein the external sources include providers of travel services, and wherein the portion of the travel information includes information associated with the user and the at least one itinerary data item about at least one of a flight, a hotel, a restaurant, a rental car, a train, a bus, an event, a ticket, a reservation, a schedule, a location, a meeting, an activity, weather information, and a travel alert.

80. The carrying case of claim 77 wherein the packing information includes the capacity of the main compartment and the packing list is based on the capacity.

81. The carrying case of claim 77 wherein the packing information includes a capability of the main compartment and the packing list is based on the capability, and wherein the capability is at least one of a garment bag capability, a shoe bag capability, a toiletries case capability, a tie container capability, a make-up case capability, a shirt container capability, a suit holder capability, a dress holder capability, an accessories holder capability, an underwear holder capability and a hosiery holder capability.

82. The carrying case of claim 81 wherein the packing list is color coded to correspond to colors of at least one of the capabilities.

83. The carrying case of claim 78 wherein the packing guidance module is configured to query the user through at least one of the interface included with the housing and an application on the user's mobile device, wherein the packing guidance module is configured to receive from the user at least one of identification of an itinerary, dates of travel, a destination, and booking information relevant to the itinerary data item, and wherein upon receiving information, the mobile computing device of the carrying case initiates a search for additional information related to at least one of the user and the itinerary data item.

84. The carrying case of claim 83 wherein the search uses the at least one identifier of the user to search at least one travel service of the user for information related to the at least one itinerary data item and associated with at least one account of the user associated with the at least one travel service.

85. The carrying case of claim 84 wherein results of the search are used by the packing guidance module to further configure the packing list.

86. The carrying case of claim 83 wherein the query to the user includes one of confirming a portion of the travel information, modifying a portion of the travel information, and indicating a purpose for travel.

87. The carrying case of claim 77 wherein the packing guidance module includes a rules engine that applies a set of rules to generate a packing list including at least one of determining a number of outfits to pack based on the at least on itinerary data item, determining types of outfits to pack based on a destination associated with the at least one itinerary data item, determining types of outfits to pack based on weather at the destination associated with the at least one itinerary data item, determining types of sunscreen to pack based on the weather at the destination associated with the at least one itinerary data item, determining types of outfits to pack based on a purpose of the itinerary data item, and determining medications to pack based on the destination associated with the at least one itinerary data item.

88. The carrying case of claim 76 wherein the travel information module includes travel information based on a profile of the user and wherein the profile of the user is based on at least one of information entered by the user in response to queries in an interface of at least one of the mobile computing device, a mobile device of the user, and a browser used by the user; information obtained by tracking the usage of the carrying case by the user over a period of time; and information inferred based on similarity of at least one of the user and usage of information related to other users.

89. The carrying case of claim 88 further comprising a packing guidance module associated with the mobile computing device, wherein the packing guidance module uses the travel information, the user profile information, and information about the carrying case to produce a packing list for the user related to the at least one itinerary data item.

90. The carrying case of claim 89 further comprising a packing list intelligence facility connected to the packing guidance module that amends the packing list based on one of packing lists by other users who have taken trips similar to those associated with the at least one itinerary data item, feedback by at least one of the other users, and feedback by the user.

91. The carrying case of claim 89 further comprising a packing list intelligence facility connected to the packing guidance module that amends the packing list based on feedback by the user including one of a post-trip survey to the user, and querying the user to determine whether items on the packing were needed or not needed.

92. The carrying case of claim 88 further comprising user profile data connected to the packing guidance module that is configured to amend the packing list based on one of a desire detailed in the user profile to always have an extra outfit for each trip, and a desire detailed in the user profile to minimize a weight of the carrying case while packing the packing list in its entirety.

93. The carrying case of claim 77 wherein the packing guidance module is configured to track levels of remaining quantities of consumables listed on the packing list and indicate to the user when replenishment of the consumables is needed.

94. The carrying case of claim 77 wherein the packing guidance module is configured to obtain information about at least one item available from at least one destination associated with the itinerary data item and alter the packing list to omit an item based on the at least one item available at the destination.

95. The carrying case of claim 94 wherein the packing guidance module is configured to instruct the mobile computing device to pre-order at least one item available from the at least one destination associated with the itinerary data item for availability of the at least one item upon arrival of the user.
